(19) United States
(12) Patent Application Publication
(10) Pub. No.: US 2003/0163600 A1
(43) Pub. Date: Aug. 28, 2003

(54) Method and system where one thread can handle several different services concurrently

(76) Inventors: Jyri Lankinen, Helsinki (FI); Mika Leppanen, Jarvenpaa (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/239,724

(22) PCT Filed: Jan. 24, 2002
(86) PCT No.: PCT/FI02/00058

(30) Foreign Application Priority Data
Jan. 26, 2001 (FI) 20010163

(51) Int. Cl. G06F 9/46; G06F 9/00

(52) U.S. Cl. 709/318; 709/107

(57) ABSTRACT

The invention relates to the structures of servers. The invention comprises the server architecture including at least one thread, which can handle several different services at the same time. The thread uses a task manager to schedule the next service to be processed. The operating system handles the execution of the thread or threads. An assignment list contains all services assigned to the thread.

### FIELD OF THE INVENTION

This invention relates to servers. Especially, the invention relates to the structures of servers, how the server has been constructed, and how the server runs services. Further, the invention especially relates to servers in the field of telecommunications.

### BACKGROUND OF THE INVENTION

FIG. 1 shows an example of a client-server environment. The server (1) may contain many services (2). The client (3) invokes a specific service in the server. The interface between the client and the service can, for instance, be based on CORBA. The service is in some state, which is changed by the client. When the service has performed desired tasks, it sends a response back to the client. This is the way, how servers handle requests from clients at present.

Servers can be constructed in many ways. All ways have their drawbacks and strong sides. One possible way is to use Java, an object-oriented programming language, to create functions of the server. Basic Java structures should be kept in mind when reading this text, describing the advantages and drawbacks of Java, and the invention.

An object is a software component that usually contains executable codes and data. In an object-oriented language actual objects are not defined, but classes of objects are. A class is a template for multiple objects with similar features. It can be said that a class describes all common features for all objects in the class. So, a single object is a concrete representation of the class, in other words an instance.

Methods are functions, i.e. executable codes that operate in a class or an object. A stream is a path of communication between the source of some information and its destination. Java contains several inputstream and outputstream classes for defining different streams. Serializing is a feature in Java environment that makes it possible to save a state of an instance of the class (the concrete representation of a class) in the form of a byte-line. Serialized instances can be deserialized making it possible to use the saved class representation later.

Threads are objects of the Thread-class. Preferably, the threads are used if the application runs several tasks simultaneously. A thread runs a task that is given to it. The task contains commands that the operating system accomplishes. Parallel threads run at the same time, i.e. the application can execute parallel commands individually, without waiting for the end of a single command before starting the next command. So, if there are several applications and/or tasks to be run simultaneously, it is useful to use a thread-modeling.

To sum up, a Java application comprises classes, which refer to objects. One of the classes is the “route” class, which contains basic methods of the application and makes it possible to get the other classes that belong to the application.

A client sends an event to the server, which has threads listening for events coming from the client. These threads pass the events upon reception to the processing threads which do the actual event processing. Each event requires its own, new, processing thread, The cooperation of the two types of threads is synchronized. However, the synchronization is always expensive and tedious to design.

The objective of the invention is to avoid these drawbacks and offer better system performance than previous solutions. This is achieved in a way described in the claims.

### SUMMARY OF THE INVENTION

The idea of the invention is that the server architecture includes at least one thread, which can handle several different services at the same time. The thread uses a task manager to schedule the next service to be processed. The operating system handles the execution of the thread or threads. An assignment list contains all services assigned to the thread. A service environment comprises a container class, which contains objects that form an actual service instance and elements for keeping service and object specific data, and for controlling the actions of the container. Further, the service environment comprises information of the state and the substate of the container, and queues for different types of events to be processed. The queues can hold events coming from the clients before the events actually are processed.

The service environment observes the states of the queues. The task manager asks the service environments in the assignment list if there are any events to be processed. If there are, the manager pulls the events in the order they are going to be processed. The thread pulls the events in order from the manager for executing in the operating system. The thread fires the event to the right service in the assignment list for starting the execution. After the execution, the state of the service environment has changed.

### BRIEF DESCRIPTION OF THE DRAWING

In the following the invention is described in more detail by means of FIGS. 1-5 in the attached drawings where.

FIG. 1 illustrates an example of a client-server environment at present,

FIG. 2 illustrates an example of a client-server environment according to the invention,

FIG. 3 illustrates an example of a server architecture for handling parallel services according to the invention.

FIG. 4 illustrates an example of a service environment according to the invention,

FIG. 5 shows an example of the method according to the invention.

### DETAILED DESCRIPTION OF THE INVENTION

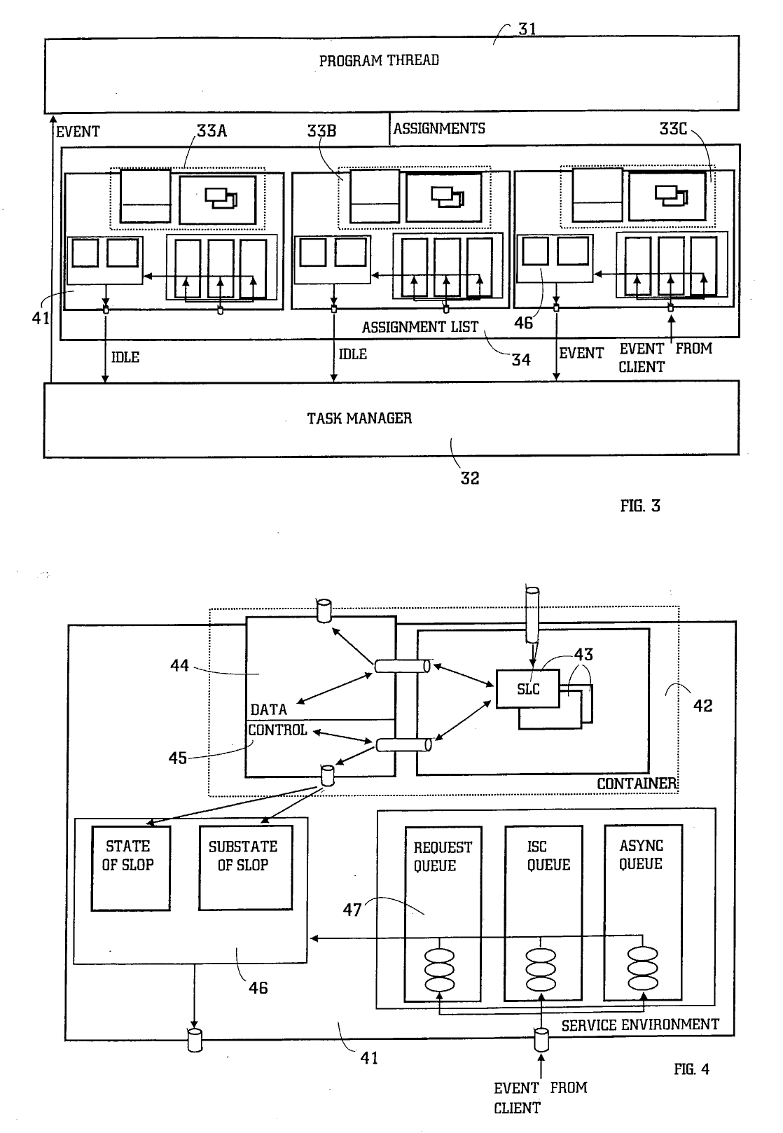

FIG. 3 shows an example of a server architecture for handling parallel services according to the invention Threads are very essential when arranging simultaneous processes to be performed. Normally, a thread handles the execution of one service. So, if there, for example, are ten parallel services, there exist ten parallel threads. However, the services run independently from each others, so there exist idle and busy threads in the view of the operating system. The idle threads consume resources of the operating system. Using the arrangement, such as in FIG. 3, according to the invention, one thread (31) can handle several services simultaneously, which saves the resources of the operating system. The server architecture according to the invention can include several parallel threads, each of them handling several services. So, one thread can comprise one to many services (or service instances of the services).

The server architecture needs a task manager (32) for handling the scheduling of executions of the services. The services (33a, 33b, 33c) assigned to the thread (31) form an assignment list (34). The task manager uses the list for pulling events from the services in the list, and scheduling the events for the thread, which pulls events for executing them from the task manager. The thread fires the execution of the events in the services.

The service environment, i.e. the program environment, is a container (FIG. 4,41) (a class) in which the service (42) (program) arid its instance (a program instance) can be accommodated, and run when it is operational in the service architecture. The program environment comprises the elements as depicted in FIG. 4.

The service environment comprises one to many queues (47) for storing messages i.e. events coming from a client. Each event represents a task which the current service instance processes.

The container comprises a common part, which in turn comprises a control part (45) and an instance context (44). The container further comprises a set of objects (43) that form the actual service. The control part executes objects (43) in accordance with events received. The instance context stores data that is specific for the service instance.

The service environment comprises information (46) of the state and the substate of the container, and queues (47) for different types of events to be processed. The events are categorized in to three types: Request, ISC, and Asynchronous events. ISC (inter-Service Communication) means that an event was sent from another service, and it can be sent either synchronously or asynchronously.

A synchronous message (event) is a message that the service is waiting for, i.e. the processing of a service event is in a waiting state and it will continue the processing when the service gets a special (synchronous) message.

An asynchronous message is a message that the service is not waiting for. However, the service must be waiting for a synchronous message, during which time it may receive unexpected messages, i.e. asynchronous messages, or the synchronous message.

Signal messages are special cases of asynchronous messages. The signal handler can handle signal messages at the same time another handler handles a synchronous or asynchronous message. The Request type handles synchronous events coming from inside the service. However, it is possible to use other types and another number of types if desired. The queues can hold events coming from clients before they actually are processed. The period of how long an event can be held depends on the service itself. The service environment registers states of the queues.

When thinking in terms of services in a communication system service platform. One service can be implemented as a program that is embedded into the service environment. In other words, the service is implemented such that its program code is implemented as objects within the container. A particular instance of the said program in execution within the service architecture thus is a service environment instance.

The container comprises a common part, which in turn comprises a control part (45) and an instance context (44). The container further comprises a set of objects (43) that form the actual service. The control part executes objects (43) in accordance with events received. The instance context stores data that is specific for the service instance.

The service environment can be, for instance, defined as a program load module, the kind of which is executable in parallel within a thread. The threads are in turn executable in parallel within an execution environment such as a Java virtual machine. Therefore, there are parallel process entities on three levels: operating system level, virtual machine level and on the thread level.

Since the service architecture is based on an object-oriented model, clients are also modeled as objects. The clients send requests or messages to the service, which are also objects that contain tasks desired by the clients. Request/message objects are called events. (It should be noted that an event can also mean another type of object.)

Let's examine an example where a service architecture is constructed to have one thread to which three services have been assigned, as the situation is in FIG. 3. Two services, 33a and 33b, are idle, but the third service 33c has an event from the client. The event is waiting in the relevant queue. The service environment has registered the states of the queues and services. If one or a number of the services is ready to take an internal event, the service environment pulls the event for the service from the Request queue, if there are any event waiting.

The task manager examines the assignment list for pulling events. According to the cycle, which the manager uses for checking the states of the services, the manager starts from service 33a. Service 33a is idle and thus doesn't have an event for execution. Also service 33b, which the manager examines next, is idle. The manager finds an event to be pulled for the execution when examining the state of service 33c. The manager pulls the event.

Normally, there are many events which have to be scheduled for execution in the task manager (32), but now, in this example, there is only one event, which the manager can schedule to be first for execution. If there are a number of services in the assignment list with events to be processed, the task manager will go through the services in a round-robin fashion and processes their events in the specified order according to the event priorities. In the service environment asynchronous events are put into an order of the priority of the events. Synchronous messages are put into an order according to the incoming order. (It should be noted that the task manager may use other ways for scheduling if other technical solution are used.) The thread pulls (31) the event from the manager, and fires the execution of the event in the service (33c). The firing means that the same thread can send (and receive) and execute an event. The execution of the event changes the state of the service environment (46) that the task manager can notice when examining this service environment.

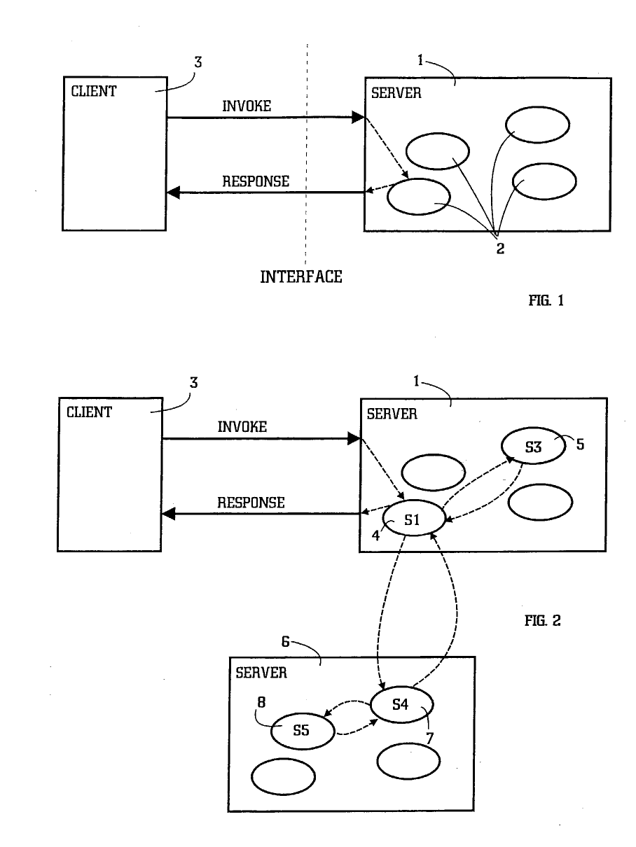

FIG. 2 shows an example of a client-server environment according to the invention. The client sends an event to server 1. The event is directed to the right service environment (S1). Since the event. can be in the queue, i.e. the service looks idle to the task manager, before the thread fires it, the service environment (S1) can use other service environments for certain tasks before the event is directed back to the thread for final execution. Due to this, the service can be constructed so that it uses other services for creating the final service. The service environment can ask another service environment (5) in the same server (1) or in another server (6). It is also possible to form a chain of service environments to create a final service. The situation is pictured in FIG. 2, where the route service environment S1 (4) asks another service environment S4 (7) in another server (6) to do a certain task or tasks, and server environment S4 in turn asks yet another server environment S5 (8) to do a certain task or tasks. The chain discharges backwards when service environment S5 fires the task or tasks responding to service environment S4, which in turn fires it's task or tasks responding to service environment S1, where finally the event returns to the thread the firing the service desired by the client. The service gives the response to the client.

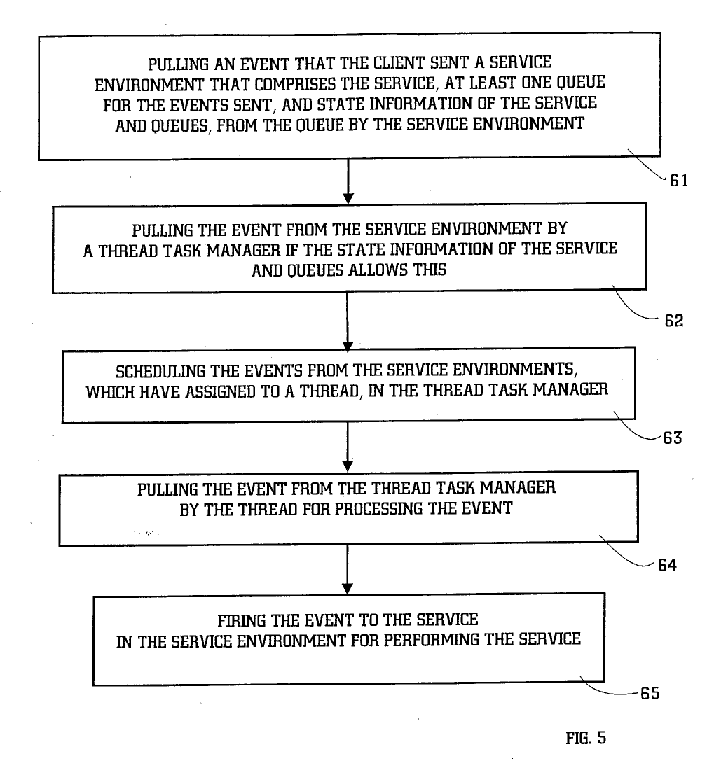

The server architecture according to the invention includes a method of performing a service. FIG. 5 shows an example of the preferable method. First (61), an event from a client, has to be pulled from the queue in the service environment that handles this service and its events. As described before, the service environment contains the actual service, at least one queue for the events pushed by clients, and state information of the service and queues.

The service environment keeps the event in the queue or allows it to be pulled (62) by the task manager. The choice depends on the state information of the service and queues. For instance, the service can be busy doing other matters, or one of the queues has another event that has to be performed first.

When the task manager has pulled the event, it schedules (63) the event with other events pulled from the other service environments in the order in which the events were pulled. These service environments have been assigned to the thread that handles the processing of the assigned service environment specific services. The scheduled events are in the order of performance of the services.

The thread pulls (64) the event in order from the task manager for processing the event. The thread fires (65) the event to the service in the service environment for performing the service. The firing means that the actual processing happens in the service, not in the thread. The thread contains the service classes of the services assigned to it, and uses these classes for performing events. It should be noted that the thread can alternatively post the event to the service. Posting means that different threads handle the execution and sending (to post) of the service. It is worth noting that the service architecture can be constructed other ways than described above. For example, the pulling acts can be created by using a pushing technique such as pushing the events from the service environments to the task manager and from the task manager to the thread. However, the use of the pulling technique as described in this text is preferable. Further, it is worth noting that the pulling order in the inventive worth noting that the pulling order in the inventive architecture can be, for example, that first, the thread pulls an event from the task manager, and after this the task manager pulls an event (events) from the service environments (the task manager does not pull events independently).

In other embodiments of the invention, for instance, the event queues are not necessarily stored in association with a given service environment instance, they can be stored elsewhere, however such that events can be retrieved by the program instance when it is notified of an incoming event. Similarly, the container part can be composed of one code module that is not necessarily composed of separate objects. Similarly, there may not be a clear separation of the code part of the program into a common control part and a service specific part.

The invention makes it possible to use the resources of the operating system more efficiently, thus a huge amount of services can run simultaneously. For each service, it looks like the thread runs only for the service itself. The service architecture according to the invention runs asynchronously, meaning that the period between the acknowledgement of the client's request and the response to the client can be anything, due to buffering. Avoiding synchronicity means cost savings. The invention also makes so-called hot services possible. This means that the state of the service is not changed by the client, but the service itself can change the state. Especially worth noting is that the service can be a client to other services.

Although, the invention is described in this text by a few examples, it is evident that the invention is not restricted to these, but it can be used in other solutions as well, in the scope of the inventive idea.

1. A server for executing a service for a client who sends events to the server in a client-server platform that comprises at least one client and at least one server, the server comprising at least one service, characterized in that the server comprises
a thread execution environment for executing threads in parallel, each thread processing the events assigned to it,
at least one of said threads handling parallel the executions of at least two service instances assigned to the thread,
a task manager for scheduling the events.

2. A server according to claim 1, characterized in that the thread execution environment comprises at least one service environment for forming a platform for one of said service instances.

3. A server according to claim 2, characterized in that the service environment comprises at least one queue for queuing the events.

4. A server according to claim 2 or 3, characterized in that the service environment further comprises state information of the service instance and queues.

5. A method for performing a service for a client who sends service specific events to the server in a client-server platform that comprises at least one client and at least one server, the server comprising at least one service, characterized in that the method comprises the steps of
pulling the event that the client sends to a service environment, that is comprised of the service, at least one queue for the events sent, and state information of the service and queues, from the queue by the service environment,
pulling the event from the service environment by a task manager if the state information of the service and, queues allows it,
scheduling the events from the service environments, which have been assigned to a thread that handles processing of the events of the assigned service environments, in the task manager,
pulling the scheduled event from the task manager by the thread for processing the service event,
firing the event to the service in the service environment for performing the service.

6. A method for performing a service for a client who sends service specific events to the server in a client-server platform that comprises at least one client and at least one server, the server comprising at least one service,characterized in that
pulling the event that the client sends to a service environment that is comprised of the service, at least one queue for the events sent, and state information of the service and queues, from the queue by the service environment,
pushing the event by the service environment to a task manager if the state information of the service and queues allows it,
scheduling the events from the service environments, which have been assigned to a thread that handles processing of the events of the assigned service environments, in the task manager,
pushing the scheduled event to the thread by the task manager for processing the service event,
firing the event to the service in the service environment for performing the service.

7. A method according to claim 5 or 6 characterized in that instead of posting the event to the service, the event is fired to the service.
